(19) United States
(12) Patent Application Publication
(10) Pub. No.: US 2006/0161777 A1
(43) Pub. Date: Jul. 20, 2006

(54) Watermark embedding and detection

(75) Inventors: Antonius Adrianus Cornelis Maria Kalker, Mountain View, CA (US); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/564,421

(22) PCT Filed: Jul. 5, 2004
(86) PCT No.: PCT/IB04/51126

§ 371 Date: Jan. 11, 2006

(30) Foreign Application Priority Data
Jul. 11, 2003 (EP) 03102118.1

(51) Int. Cl. H04L 9/00

(52) U.S. Cl. 713/176

(57) ABSTRACT

Disclosed are methods and systems for embedding and for detecting digital watermarks in information signals. The method of embedding a watermark comprises the steps of providing a watermark secret (106), embedding (107) a digital watermark in an information signal (101) where said embedding is controlled by the watermark secret, calculating (102) a digital fingerprint (103) from the information signal, and storing (104) the calculated digital fingerprint as a reference digital fingerprint and storing, in relation to the reference digital fingerprint, a identifier data item from which the watermark secret can be derived.

The invention relates to embedding and detecting digital watermarks in information signals.

In the context of digital signal distribution, e.g. the distribution of multimedia content via the Internet, it is generally desirable to be able to provide protection against unauthorized further distribution of the distributed signals. For example, this is an important issue in the context of distributing copyright protected material. An example of such a scenario is an electronic music delivery system where audio content, e.g. songs, is distributed from a server computer via the Internet to one or more client computers.

Digital watermarks may be embedded in the distributed information signals in order to label the distributed content and allowing the distributor or another authority to track the distributed content, e.g. to track the content sent to individual users.

A potential threat to the tracking of distributed information signals by embedded digital watermarks is the so-called copy-attack. In such an attack, a malicious user estimates the digital watermark embedded in an information signal and embeds the estimated watermark in another information signal representing different information content.

The article “Image watermarking for tamper detection” by Jiri Fridrich, Proc. ICIP'98, Chicago, 1998, discloses a method of embedding a watermark in a digital image by a digital camera, wherein the watermark sensitively depends on a secret key of the digital camera and continuously depends on the image features. Hence, in this prior art method, the generated watermark depends on the content of the digital image, thereby reducing the risk of an unauthorized copying of the watermark to other images.

However, it is a problem of the above prior art method that degradations of the content, e.g. due to compression losses, etc., the feature retrieval process may fail, thereby also reducing the reliability of the watermark detection as the detection process depends on these feature data.

The above and other problems are solved by a method of embedding a digital watermark in an information signal; the method comprising
providing a watermark secret;
embedding a digital watermark in an information signal where said embedding is controlled by the watermark secret;
calculating a digital fingerprint from the information signal;
storing the calculated digital fingerprint as a reference digital fingerprint and storing, in relation to the reference digital fingerprint, a identifier data item from which the watermark secret can be derived.

Hence, by storing the calculated digital fingerprint as a reference fingerprint associated with the watermark secret used in the watermark embedding, a robust mechanism is provided for a subsequent watermark detector to identify the content-specific watermark secret. Since the watermark secret is stored in relation to a digital fingerprint of the information content, it may subsequently be identified by a detection system, Furthermore, the identified fingerprint is not unrecognizably degraded due to possible degradation of the information signal, thereby allowing retrieval of the watermark secret and enhancing the ability to correctly detect the watermark.

Furthermore, since different watermark secrets are associated to different information content, the above-described copy attack of an estimated watermark from one information signal to another information signal carrying a different information content would result in a watermark with an invalid secret, i.e. a watermark that will not be successfully detected. Hence, it is an advantage that a high security against copy-attacks is provided.

For the purpose of the present description, the term information signal refers to any analog or digital signal or data comprising information content, in particular perceptual information to be distributed, such as images, moving pictures, audio, or combinations of the above. Examples of such information signals include multimedia signals, such as video signals, audio signals, images, pictures, etc. In some embodiments the information content is encoded as a digital information signal. For example, audio signals may be encoded according to an audio coding scheme, e.g. MPEG-1, MPEG-2, MPEG-2 AAC, or the like.

Here, the term digital fingerprint comprises a data item resulting from any suitable method of extracting robust features from an information signal indicative of the information content in such a signal, and storing the extracted features in a compact form. Hence, a fingerprint is a representation of the corresponding information content in question. Preferably, the fingerprint is shorter than the original information signal. Furthermore, the fingerprint preferably represents the most relevant perceptual features of the information signal in question. Such fingerprints are sometimes also known as “robust hashes”. The term robust hashes refers to a hash function which, to a certain extent, is robust with respect to data processing and signal degradation, e.g. in the case of audio signal such degradation may occur due to compression/decompression, coding, AD/DA conversion, etc. Robust hashes are sometimes also referred to as robust summaries, robust signatures, or perceptual hashes.

According to the invention, the fingerprints of a large number of information contents are stored, e.g. in a database, as reference fingerprints. For example, such a database may comprise a large number of songs, their fingerprints and associated watermark secrets or at least identifier data items from which the watermark secrets can be derived. Hence, during watermark detection, the content in an information signal is recognized by computing a fingerprint of the associated information content and by performing a lookup or query in the database using the computed fingerprint as a lookup key or query parameter.

In some embodiments, each database record may comprise a reference fingerprint and the corresponding watermark secret. Hence, the identifier data item may directly include the watermark secret. In other embodiments, each database record may comprise an identifier data item from which the watermark secret is derivable according to a predetermined function. For example, the identifier data item may be or include a content identifier, e.g. a song identifier in a song database, identifying the information content related to the reference fingerprint. The watermark secret may then be determined as a function of the content identifier. This has the advantage that a general-purpose fingerprint database proving content identifiers may be used.

There are several advantages in storing fingerprints in a database instead of the information signal itself. To name a few: The memory/storage requirements for the database are reduced.

The comparison of fingerprints is more efficient than the comparison of the information signal, as fingerprints are substantially shorter than the signals they are calculated from.

Searching in a database for a matching fingerprint is more efficient than searching for a complete information signal, since it involves matching shorter items.

Searching for a matching fingerprint is more likely to be successful, as small changes to an information signal (such as encoding in a different format or changing the bit rate) do not affect the fingerprint.

An example of a method of generating an audio fingerprint is described in Jaap Haitsma, Ton Kalker and Job Oostveen, “Robust Audio Hashing For Content Identification”, International Workshop on Content-Based Multimedia Indexing, Brescia, September 2001, which discloses the computation of audio fingerprints and the obtaining of identifiers from them as such.

The term digital watermark comprises any digital data item which is to be embedded in an information signal by modifying samples of the signal. Preferably, a watermarking scheme should be designed such that the watermark is imperceptible, i.e. that it does not affect the quality of the information signal significantly. In many applications, the watermark should further be robust, i.e. it should still be reliably detectable after possible signal processing operations. For the purpose of this description, the digital watermark includes a watermark payload comprising the actual message to be added to the information signal. The digital watermark is embedded on the basis of a watermark secret, also called watermarking key.

The term watermark secret refers to a secret parameter required for the watermark embedding/detection and/or for the extraction of the payload from the watermark An example of such a parameter is a pseudo-random spreading sequence in a spread-spectrum watermarking scheme as presented in M. D. Swanson, B. Zhu, A. H. Tewfik and L. Boney, “Robust audio watermarking using perceptual masking,” Signal Processing, vol. 66, pp. 337-355, 1998.

It is yet another advantage of the invention that the relationship between the fingerprint and the watermark secret does not necessarily rely on any predetermined algorithm. The relationship may be arbitrarily selected, preferably as a one-to-one relationship allowing a unique identification of the watermark secret from the fingerprint data and vice versa.

In a preferred embodiment, the watermark secret is related to the reference fingerprint by a function which is computationally hard or infeasible to invert, e.g. a one-way hash function. Hence, the function comprises any transformation H that takes an input x and returns an output h=H(x), such that, for a given value h it is computationally infeasible to find some input x such that H(x)=h. Consequently, it is computationally infeasible for an unauthorized user without access to the fingerprint database to estimate the watermark secret for a given fingerprint, thereby increasing the security of the method.

In another preferred embodiment, the watermark secret is determined by a random process unrelated or at least only partially related to the fingerprint.

In yet another preferred embodiment, the digital watermark comprises a watermark payload that is indicative of the information signal. Preferably, the method further comprises encoding said watermark payload based on an encryption key derived from an identifier indicative of an information content of the information signal. Consequently, the payload is dependant on the information content, thereby further reducing the risk of copy-attacks.

Further preferred embodiments are disclosed in the dependant claims.

The present invention can be implemented in different ways including the method described above and in the following, further methods and systems, and further product means, each yielding one or more of the benefits and advantages described in connection with the first-mentioned method, and each having one or more preferred embodiments corresponding to the preferred embodiments described in connection with the first-mentioned method and disclosed in the dependant claims.

Accordingly, the invention further relates to a method of detecting a digital watermark in an information signal; the method comprising
providing a plurality of digital reference fingerprints each calculated from a respective reference information signal, where each digital fingerprint is associated with a corresponding watermark secret;
calculating a digital fingerprint from an information signal;
determining a matching digital fingerprint from the plurality of digital reference fingerprints as corresponding to the calculated digital fingerprint;
detecting whether a digital watermark according to the watermark secret associated with the matching digital fingerprint is present in the information signal.

The reference fingerprints may be stored in a database at a remote location, for example on a server connected to the Internet or to another communications network. In this embodiment, a client device computes the fingerprint and sends it to the server via the internet or other communications network, and the server returns a corresponding identifier data item from which the associated watermark secret can be derived. Hence the step of determining a matching digital fingerprint comprises sending a query to said fingerprint database, the query comprising the calculated digital fingerprint, and receiving from the fingerprint database a response including the watermark secret associated to the matching digital fingerprint.

In yet another preferred embodiment, the step of determining a matching digital fingerprint comprises performing a search in the fingerprint database on the basis of reliability information of the extracted fingerprint bits.

In yet another preferred embodiment, the information signal comprises an encoded information signal, and the step of calculating a digital fingerprint comprises decoding the encoded information signal, and calculating the fingerprint from the decoded information signal. Consequently, the actual fingerprint is independent of the coding scheme, thereby allowing a more efficient and reliable retrieval of a fingerprint from the database which matches the actual information content irrespective of coding. Here, the term coding is intended to also include compression schemes.

It is noted that the features of the methods described above and in the following may be implemented in software and carried out in a data processing system or other processing means caused by the execution of computer-executable instructions. The instructions may be program code means loaded in a memory, such as a RAM, from a storage medium or from another computer via a computer network Alternatively, the described features may be implemented by hardwired circuitry instead of software or in combination with software.

Here and in the following, the term processing means comprises general- or special-purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

The invention further relates to an arrangement for embedding a digital watermark in an information signal; the arrangement comprising
means for embedding a digital watermark in an information signal where said embedding is controlled by a watermark secret;
means for calculating a digital fingerprint from the information signal; and
means for storing the calculated digital fingerprint as a reference digital fingerprint and for storing, in relation to the reference digital fingerprint, a identifier data item from which the watermark secret can be derived.

The invention further relates to an arrangement for detecting a digital watermark in an information signal; the arrangement comprising
means for providing a plurality of digital reference fingerprints each calculated from a respective reference information signal, where each digital fingerprint is associated with a corresponding watermark secret;
means for calculating a digital fingerprint from an information signal;
means for determining a matching digital fingerprint from the plurality of digital reference fingerprints as corresponding to the calculated digital fingerprint; and
means for detecting whether a digital watermark according to the watermark secret associated with the matching digital fingerprint is present in the information signal.

The means for providing a number of reference fingerprints may comprise a storage medium for storing such data items and/or communications means for receiving such data items and/or any other circuitry or device suitable for providing such data items.

In particular, the means for providing a plurality of digital reference fingerprints may comprise any circuitry or device for accessing a storage medium. For example the above means may comprise any circuitry or device for communicating data, e.g. via a wired or a wireless data link. Examples of such communications circuit or device include a network interface, a network card, a radio transmitter/receiver, a cable modem, a telephone modem, an Integrated Services Digital Network (ISDN) adapter, a Digital Subscriber Line (DSL) adapter, a satellite transceiver, an Ethernet adapter, or the like.

Alternatively or additionally, the means for providing a plurality of digital reference fingerprints may comprise a suitable storage medium for storing the digital reference fingerprints. Examples of a storage medium include a magnetic tape, an optical disc, a digital video disk (DVD), a compact disc (CD or CD-ROM or the like), a mini-disc, a hard disk, a floppy disk, a ferro-electric memory, an electrically erasable programmable read only memory (EEPROM), a flash memory, an EPROM, a read only memory (ROM), a static random access memory (SRAM), a dynamic random access memory (DRAM), a synchronous dynamic random access memory (SDRAM), a ferromagnetic memory, a optical storage, a charge coupled device, a smart card, a PCMCIA card, etc.

The invention further relates to a database system comprising
a storage medium having stored thereon a plurality of digital reference fingerprints each calculated from a respective reference information signal, and having stored thereon, in relation to each of the digital reference fingerprints, a respective identifier data item from which a corresponding watermark secret associated to said digital fingerprint can be derived;
means for receiving a request from a watermark processing system for a watermark secret suitable as an input for embedding a digital watermark in an information signal, the request comprising a digital fingerprint calculated from the information signal by the watermark processing system;
means for determining a matching digital fingerprint from the plurality of digital reference fingerprints as corresponding to the calculated digital fingerprint; and
means for sending a response to the watermark processing system, the response comprising the identifier data item stored in relation to the determined matching digital fingerprint.

These and other aspects of the invention will be apparent and elucidated from the embodiments described in the following with reference to the drawing in which:

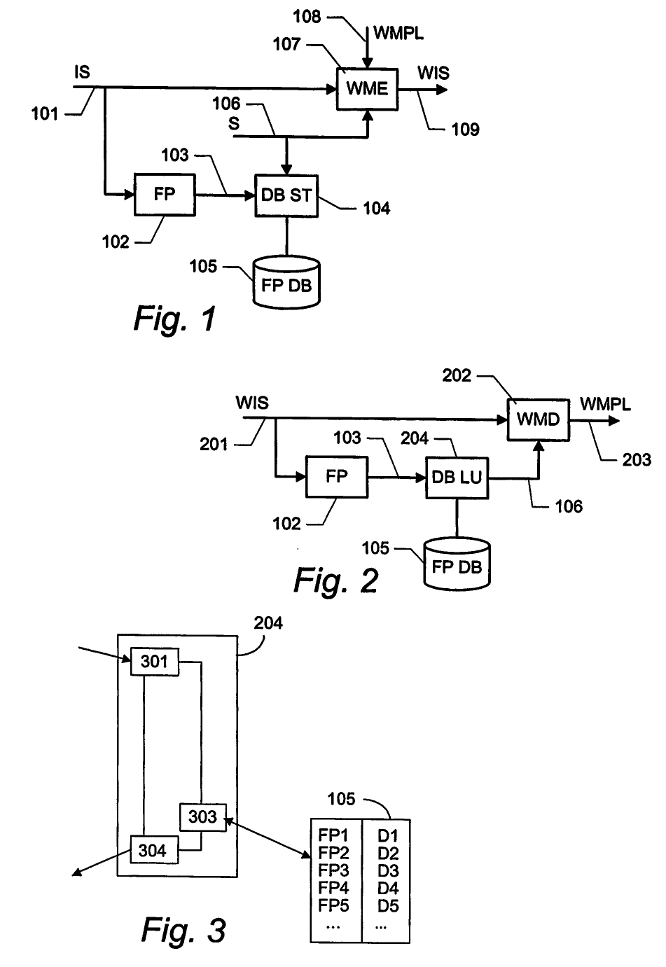

FIG. 1 shows a block diagram of an embodiment of a system for embedding a watermark;

FIG. 2 shows a block diagram of an embodiment of a system for detecting a watermark;

FIG. 3 schematically shows an embodiment of a fingerprint database module;

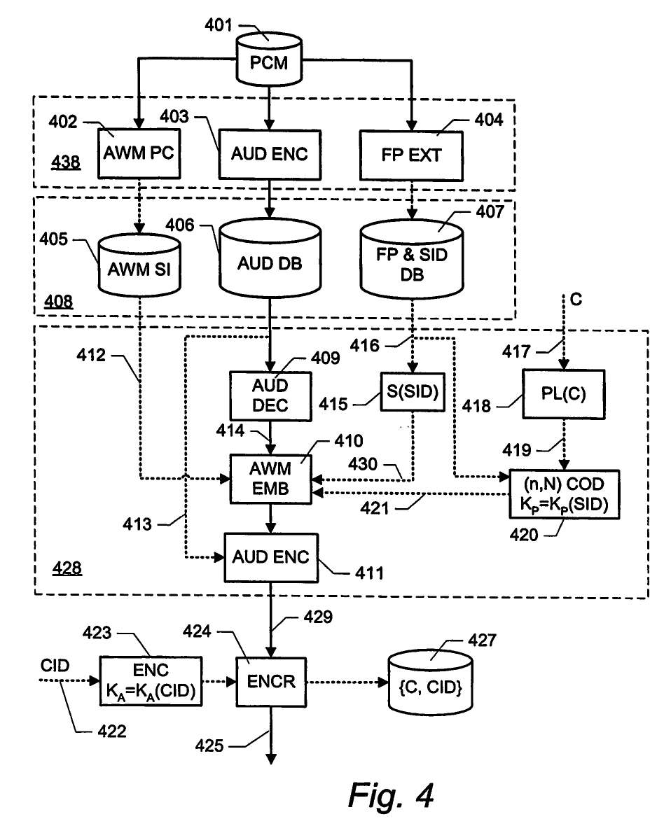

FIG. 4 shows a block diagram of an embodiment of a music delivery system with watermark embedding; and

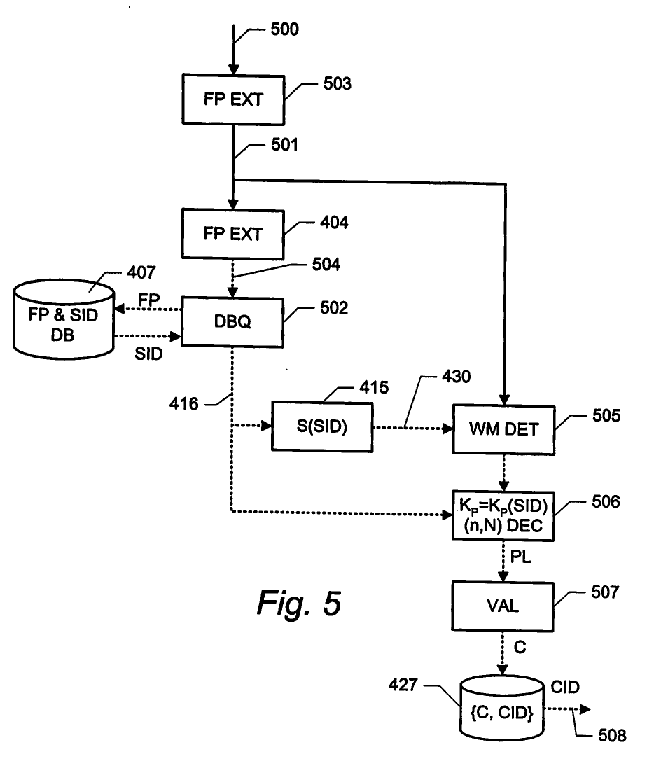

FIG. 5 shows a block diagram of a watermark detection system of the music delivery system of FIG. 4.

FIG. 1 shows a block diagram of an embodiment of a system for embedding a watermark. The system receives an information signal 101 into which a watermark 108 is embedded resulting in a watermarked information signal 109. The system comprises a fingerprint calculation block 102 that receives the information signal 101 and computes one or more fingerprints 103 from the information content of the information signal.

The system further comprises a fingerprint database storage module 104 which receives the calculated fingerprint(s) 103 from the fingerprint calculation block 102 and a watermark secret 106 to be associated with that fingerprint. The watermark secret may be generated on the basis of the fingerprint(s) calculated by the fingerprint calculation block 102 or independently of the fingerprint.

It is noted that, Instead of a database 105, the reference fingerprints may be stored in a different way, e.g. as files in a file systems. It is an advantage of a database system that it allows an efficient search when a large number of reference fingerprints are stored.

The system further comprises a watermark embedding module 107 that receives information signal 101, the watermark secret 106, and a watermark payload 108 to be embedded in the information signal 101. The watermark embedding module embeds the watermark payload 108 in the information signal on the basis of the watermark secret 106 and generates a corresponding watermarked information signal 109 having the watermark 108 embedded in it. The watermark secret 106 determines one or more parameters of the embedding process. Without knowledge of the watermark secret the watermark payload cannot be extracted from the watermarked signal. For example without knowledge of the spreading sequence as described in M. D. Swanson, B. Zhu, A. H. Tewfik and L. Boney, “Robust audio watermarking using perceptual masking,” Signal Processing, vol. 66, pp. 337-355, 1998, the watermark embedded in the information carrier nor its payload can be detected.

FIG. 2 shows a block diagram of a system for detecting a watermark. The detection system comprises a fingerprint calculation block 102, and a fingerprint database 105 as described in connection with FIG. 1. The detection system receives a watermarked information signal 201 which is fed into the fingerprint calculation block 102. The calculated fingerprint 103 is fed into a fingerprint database module 204 which has access to the fingerprint database 105. Based on a comparison of the calculated fingerprint(s) and the reference fingerprints in the database 105, the fingerprint database module 204 identifies a matching reference fingerprint and retrieves the corresponding associated watermark secret 106.

The watermark secret 106 is fed into a watermark detection block 202 which also receives the watermarked information signal 201. The watermark detection block 202 detects the embedded watermark on the basis of the watermark secret, extracts the watermark payload, and outputs the watermark payload 203.

FIG. 3 schematically shows an embodiment of a fingerprint database module. The fingerprint database module 204 comprises an input module 301, a Database Management System (DBMS) backend module 303, and a response module 304.

The input module 301 receives an audio fingerprint and supplies the fingerprint to the DBMS backend module 303. The DBMS backend module 303 performs a query on the database 105 to identify any matching reference fingerprints and to retrieve any additional data associated with the matching reference fingerprint. As shown in FIG. 3, the database 105 comprises fingerprints FP1, FP2, FP3, FP4 and FP5 and respective associated sets of additional information D1, D2, D3, D4 and D5, including content identifiers and/or watermark secrets and/or other identifier data items. International patent application WO 02/065782, which is included herein by reference in its entirety, describes various matching strategies for matching fingerprints computed for an audio clip with fingerprints stored in a database. International patent application WO 02/065782 further discloses an efficient method of matching a fingerprint representing an unknown information signal with a plurality of fingerprints of identified information signals stored in a database to identify the unknown signal. This method uses reliability information of the extracted fingerprint bits. The fingerprint bits are determined by computing features of an information signal and thresholding said features to obtain the fingerprint bits. If a feature has a value very close to the threshold, a small change in the signal may lead to a fingerprint bit with opposite value. The absolute value of the difference between feature value and threshold is used to mark each fingerprint bit as reliable or unreliable. The reliabilities are subsequently used to improve the actual matching procedure.

The database 105 can be organized in various ways to optimize query time and/or data organization. The output from the input module 301 should be taken into account when designing the tables in the database 105. In the embodiment shown in FIG. 3, the database 105 comprises a single table with entries (records) comprising respective fingerprints and identifier data items. The DBMS backend module 303 feeds the results of the query to the response module 304, which returns the results to a requesting application, e.g. a watermark detection system as described above and in the following.

In one embodiment, each reference fingerprint is stored together with an associated watermark secret. In other embodiments, each reference fingerprint is stored together with a content identifier such that a watermark secret can be calculated from the content identifier.

FIG. 4 shows a block diagram of an embodiment of a music delivery system with watermark embedding. The system comprises a content database 401 comprising the original audio tracks, e.g. represented as a sequence of sample values such as in a pulse code modulation (PCM) representation. In a pre-processing module 438, the content stored in the database 401 is processed resulting in pre-processed information which is stored in a database system 408. In particular, the pre-processing module 438 comprises a audio watermarking (AWM) pre-calculation module 402 that receives the PCM audio tracks and processes them, resulting in Information to be used by the subsequent watermark embedding. This information will be referred to as AWM side information. Examples of side-information that can be pre-calculated comprise for example psycho-acoustic model parameters and local watermark power values. Hence, by providing pre-calculated information that does not depend on the watermark secret, the subsequent watermark embedding process is more efficient. The pre-calculated side-information is stored in a database 405 of the database system 408. The pre-processing module 438 further comprises an encoder module 403 that encodes the original audio tracks according to a suitable audio coding (AC) scheme, e.g. according to the advanced audio coding (AAC) scheme or any other suitable standard or proprietary scheme. The encoded audio tracks are stored in a content database 406 of the database system 408. The pre-processing module 438 further comprises a fingerprint extraction module 404 which calculates one or more fingerprints from the original audio tracks. The extracted fingerprint is stored together with a song ID identifying the audio track in a fingerprint database 407 of the database system 408. An example of a method of generating an audio fingerprint is described in Jaap Haitsma, Ton Kalker and Job Oostveen, “Robust Audio Hashing For Content Identification” (ibid.).

The system further comprises a watermarking module 428 that receives an encoded audio track from the content database 406, the corresponding AWM side information from the database 405, and the corresponding song ID (SID) 416 from the fingerprint database 407. The watermarking module further receives a song counter C identifying the current instance of the song. For example, the counter may be incremented each time the watermarking process is invoked, thereby identifying the actual audio file generated by the embedding process. From the above input, the watermarking module 428 generates a watermarked encoded audio file 429.

In particular, the watermarking module 428 comprises a mono decoder 409 for decoding the encoded audio file received from the content database 403. The mono decoder generates a mono audio file 414, e.g. a mono PCM file and feeds the mono audio file into a watermark embedding module 410. The watermark embedding module further receives the AWM side information 412 corresponding to the current audio file based on which the watermark is embedded. The watermark embedding module 410 further receives a content-dependant watermark secret 430 from a secret generator 415 and a watermark payload 421 from a payload encoder 420. The watermark embedding module 410 embeds the watermark payload 421 into the mono PCM file 414 according to the received watermark secret 430 and the watermark side information 412 and feeds the watermarked PCM file into an encoder module 411. The encoder module 411 re-encodes the watermarked audio file resulting in the watermarked encoded audio file 429. Preferably, the re-encoder 411 further receives additional encoding information, such as AAC side information, for ensuring an efficient re-encoding of the original audio information.

The secret generator 415 generates the secret 430 based on a song ID (416) corresponding to the current audio file as received from the fingerprint database 407. Consequently, for each song ID a different secret S=Secret(SID) is generated. In one embodiment, the function Secret(SID) is a function which is computationally hard to invert, e.g. a one-way hash function of the song ID.

The payload encoder 420 receives a watermark payload from a payload generator 418 and the song ID 416 from the fingerprint database. The payload generator, in turn, receives the song counter C (417) and generates a counter dependant payload 419 according to PL=Payload(C) for an appropriately chosen function ‘Payload’. The payload encoder 420 performs an (n,N) encoding of the counter-dependant payload 419 using a song dependant encryption key K_{P}. In particular, the payload encoder receives the song ID (SID), generates a cryptographic key K_{P}=K_{P}(SID) as a function of the song ID, and generates a codeword from the payload 419 and the cryptographic key K_{P}. Hence, assuming that the payload 419 comprises n bits, the (n,N) coding results in a codeword comprising N bits, where N>n and where the n-bit word is extended by adding appropriately stuffing bits, for example all zeroes, and subsequently encrypting the N-bit code word with the key K_{P} to a final N-bit code word. It is noted that only certain N-bit words constitute valid codewords of the (n,N) coding, thereby reducing the risk of false positive codewords, i.e. the risk of accidentally generating a valid counter sequence.

Consequently, the payload encoder generates a payload P=P(PL,K_{P}) which is fed into the watermark embedder. It is an advantage that the payload P is dependant on the payload counter C and the song ID, thereby reducing the risk of successful copy-attacks and allowing the tracking of a generated audio file.

The system further comprises an encryption module 424 that receives the watermarked audio file 429 from the watermark module. The encryption module 424 further receives an encryption key K_{A} from a key generation module 423. The key generation module 423, in turn, receives a customer or client ID (CID) 422 of the customer or client to which the generated watermarked audio file is to be distributed. From the customer ID, the key generation module generates a cryptographic key K_{A}=K_{A}(CID) according to any suitable cryptographic key-generation algorithm. The encryption module 424 encrypts the watermarked encoded audio file 429 based on the key K_{A} resulting in an encrypted watermarked encoded audio file 425 which is ready for distribution to the customer, where the encryption module 424 may implement an encryption algorithm such as triple-DES, AES or any other appropriately chosen algorithm. For example, the file 425 may be forwarded to a download server that forwards it to the requesting client via a computer network. The encryption module 424 further stores an entry in a log database 427, the entry comprising the song counter C identifying the generated audio file and the customer ID (CID), thereby allowing the tracking of the distribution of the current audio file to the specific customer.

FIG. 5 shows a block diagram of a watermark detection system of the music delivery system of FIG. 4. The detection system receives an encoded watermarked audio file 500. The detection system comprises a decoding module 503 which decodes the encoded file and generates a decoded audio file 501, e.g. a mono PCM file, which is fed into a fingerprint extraction module 404 as described in connection with FIG. 4. The extracted fingerprint 504 is fed into a database module 502 which queries the fingerprint database 407 described above using the extracted fingerprint as a key. As a result of the query, the database module 502 retrieves a song ID (SID) corresponding to the fingerprint from the database 407. If no matching fingerprint is found the detection system aborts the watermark detection and generates a corresponding error message. The database module 502 forwards the retrieved song ID 416 to a secret generator 415 which generates a watermark secret corresponding to the song ID, as was described in connection with FIG. 4. The watermark secret 430 is forwarded into a watermark detection module 505 which receives the watermarked audio file 501 and the watermark secret 430 and which extracts the watermark from the audio file according to the secret 430. The extracted watermark is fed into a payload decoding module 506 which decodes the watermark payload from the watermark. The decoding module 506 performs an inverse operation of the payload encoder 420 of FIG. 4, i.e. the payload decoding module 506 receives the song ID from the database module 502, generates a cryptographic key K_{P}=K_{P}(SID), and performs an (n,N) decoding with this key K_{P} resulting in the decoded payload. The decoded payload is fed into validation module 507 which calculates the song counter C from the payload PL and queries the log database 427 described in connection with FIG. 4 in order to retrieve the corresponding customer ID 508. Hence, the validation module 507 implements an inversion of the process implemented by module 418 of FIG. 4 in order to determine the song counter C. The customer or client ID (CID) retrieved from the log table 427 may then be used to track the watermarked audio file 501 back to the customer or the client ID to which it was originally distributed.

It is noted that the above arrangements may be implemented as general—or special—purpose programmable microprocessors, Digital Signal Processors (DSP), Application Specific Integrated Circuits (ASIC), Programmable Logic Arrays (PLA), Field Programmable Gate Arrays (FPGA), special purpose electronic circuits, etc., or a combination thereof.

It should be noted that the above-mentioned embodiments illustrate rather than limit the invention, and that those skilled in the art will be able to design many alternative embodiments without departing from the scope of the appended claims.

For example, the invention is not limited to audio files but may be used in connection with any other information signal, such as movies, pictures, multimedia data, or the like.

In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements.

The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A method of embedding a digital watermark in an information signal; the method comprising
providing (415) a watermark secret (106, 430);
embedding (107,410) a digital watermark (421) in an information signal (101,414) where said embedding is controlled by the watermark secret;
calculating (102,404) a digital fingerprint (103) from the information signal;
storing (104) the calculated digital fingerprint as a reference digital fingerprint and storing, in relation to the reference digital fingerprint, a identifier data item (SID) from which the watermark secret can be derived.

2. A method according to claim 1, wherein the information signal is an audio signal, the digital fingerprint is an audio fingerprints, and the digital watermark is an audio watermark.

3. A method according to claim 1, wherein storing the calculated digital fingerprint and said identifier data item comprises storing the calculated digital fingerprint and the identifier data item in a fingerprint database (105,407).

4. A method according to claim 1, wherein the watermark secret is related to the calculated fingerprint by a function which is computationally infeasible to invert.

5. A method according to claim 1, wherein the watermark secret is determined by a random process.

6. A method according to claim 1, where the digital watermark comprises a watermark payload (419) and wherein the watermark payload is indicative of the information signal.

7. A method according to claim 6, further comprising encoding (420) said watermark payload based on an encryption key (K_{P}) derived from an identifier (416) indicative of an information content of the information signal.

8. A method according to claim 1, wherein the information signal is a video signal.

9. A method of detecting a digital watermark in an information signal (500); the method comprising
providing (407) a plurality of digital reference fingerprints each calculated from a respective reference information signal, where each digital fingerprint is associated with a corresponding watermark secret;
calculating (404) a digital fingerprint from an information signal;
determining (502) a matching digital fingerprint from the plurality of digital reference fingerprints as corresponding to the calculated digital fingerprint;
detecting (505) whether a digital watermark according to the watermark secret associated with the matching digital fingerprint is present in the information signal.

10. A method according to claim 9, wherein determining a matching digital fingerprint comprises sending a query to a fingerprint database, the query comprising the calculated digital fingerprint; and receiving from the fingerprint database a response including a identifier data item from which the watermark secret associated with the matching digital fingerprint can be derived.

11. A method according to claim 10, wherein sending a query and receiving a response comprise communicating via a communications network.

12. A method according to claim 9, wherein the information signal comprises an encoded information signal; and calculating the digital fingerprint comprises decoding the encoded information signal, and calculating the fingerprint from the decoded information signal.

13. A method according to claim 10, wherein determining a matching digital fingerprint comprises performing a search in a fingerprint database based on reliability information about the calculated digital fingerprint.

14. An arrangement for embedding a digital watermark in an information signal; the arrangement comprising
means (107, 428) for embedding a digital watermark in an information signal where said embedding is controlled by a watermark secret;
means (102, 404) for calculating a digital fingerprint from the information signal; and
means (105, 407) for storing the calculated digital fingerprint as a reference digital fingerprint and for storing, in relation to the reference digital fingerprint, a identifier data item from which the watermark secret can be derived.

15. An arrangement for detecting a digital watermark in an information signal; the arrangement comprising
means (105, 407) for providing a plurality of digital reference fingerprints each calculated from a respective reference information signal, where each digital fingerprint is associated with a corresponding watermark secret;
means (102, 404) for calculating a digital fingerprint from an information signal;
means (204, 502) for determining a matching digital fingerprint from the plurality of digital reference fingerprints as corresponding to the calculated digital fingerprint; and
means (202, 505) for detecting whether a digital watermark according to the watermark secret associated with the matching digital fingerprint is present in the information signal.

16. A database system comprising
a storage medium (105, 407) having stored thereon a plurality of digital reference fingerprints each calculated from a respective reference information signal, and having stored thereon, in relation to each of the digital reference fingerprints, a respective identifier data item from which a corresponding watermark secret associated to said digital fingerprint can be derived;
means (301) for receiving a request from a watermark processing system for a watermark secret suitable as an input for embedding a digital watermark in an information signal, the request comprising a digital fingerprint calculated from the information signal by the watermark processing system;
means (303) for determining a matching digital fingerprint from the plurality of digital reference fingerprints as corresponding to the calculated digital fingerprint; and
means (304) for sending a response to the watermark processing system, the response comprising the identifier data item stored in relation to the determined matching digital fingerprint.
